(19) United States
(12) Patent Application Publication
(10) Pub. No.: US 2024/0047797 A1
(43) Pub. Date: Feb. 8, 2024

(54) Cylindrical Battery and Assembly Thereof

(71) Applicant: JIANGSU ZENERGY BATTERY TECHNOLOGIES CO., LTD., Jiangsu (CN)

(72) Inventors: Zhikang WU, Jiangsu (CN); Shengli CHEN, Jiangsu (CN); Yongjun LI, Jiangsu (CN)

(21) Appl. No.: 18/230,489

(22) Filed: Aug. 4, 2023

(30) Foreign Application Priority Data
Aug. 4, 2022 (CN) 202222038839.7

(51) Int. Cl. H01M 50/152; H01M 50/107; H01M 50/538; H01M 50/597

(52) U.S. Cl. CPC H01M 50/152; H01M 50/107; H01M 50/538; H01M 50/597

(57) ABSTRACT

Disclosed are a cylindrical battery and a cylindrical battery assembly which relate to the technical field of battery production and manufacturing. The cylindrical battery assembly includes a housing and a top cover assembly, the housing is provided with an opening, the top cover assembly seals the opening in an insulating manner, the top cover assembly includes a first top cover, a second top cover and an insulating part, the polarity of the first top cover is opposite to the polarity of the second top cover, the first top cover is connected to the second top cover in an insulating manner by an insulating part, a directive structure is arranged on the housing and/or the top cover assembly, and the directive structure and the cylindrical battery assembly are arranged in a non-coaxial manner.

### CROSS-REFERENCE TO RELATED APPLICATION

The disclosure claims priority to and the benefit of Chinese Patent Application No. 202222038839.7, filed to the China National Intellectual Property Administration (CH IPA) on 4 Aug. 2022, which is hereby incorporated by reference in its entirety.

### TECHNICAL FIELD

The disclosure relates to the technical field of battery production and manufacturing, and in particular to a cylindrical battery and an assembly thereof.

### BACKGROUND

Nowadays, along with rapid growth of population and rapid development of social economy, resources and energy are increasingly in short, environmental protection receives increasing attention, and development and saving of energy has become an important issue in the world today. Energy is a basis for the existence and development of human society, and the current society based on mineral energy is increasingly frequently encountered with energy shortage and environmental pollution crisis. At the same time, forms of energy application are changing, and the need for renewable, pollution-free, and small-sized mobile high-performance power supply grows rapidly in conjunction with an information-based high-tech age. Various countries develop green and efficient secondary batteries vigorously. As a new type of secondary battery, a lithium-ion battery has the advantages of high energy density and power density, high working voltage, light weight, small size, long cycle life, good safety, environmental protection, etc., and has broad application prospects in portable electrical appliances, electric tools, large energy storage, electric traffic power supply, etc.

When a cell of a cylindrical battery leads out a positive electrode tab and a negative electrode tab on a same side, a positive electrode top cover and a negative electrode top cover are located at the same end of a housing, and the positive electrode top cover and the negative electrode top cover are both provided with connecting parts for electrically connecting to the outside. Since the shapes of the positive and negative top covers are similar, and the shapes of the positive and negative connecting parts are similar, it is difficult to distinguish the positive and negative electrodes during the assembly process of the cylindrical battery, which may easily lead to the cylindrical battery being connected to an external electrical connecting sheet in reversed polarity, resulting in potential safety hazards.

### SUMMARY

The disclosure aims to provide a cylindrical battery assembly for the defects in the related art, so as to solve the problem that a cylindrical battery is easily connected to an external electrical connecting sheet in reversed polarity due to the fact that a positive electrode post and a negative electrode post of the cylindrical battery are difficult to distinguish during the assembly process.

In order to achieve the above object, the disclosure adopts the following technical solutions.

Some embodiments of the disclosure provide a cylindrical battery assembly, including a housing and a top cover assembly, the housing is provided with an opening, the top cover assembly seals the opening in an insulating manner, the top cover assembly includes a first top cover, a second top cover and an insulating part, the polarity of the first top cover is opposite to the polarity of the second top cover, the first top cover is connected to the second top cover in an insulating manner by the insulating part, a directive structure is arranged on the housing and/or the top cover assembly, and the directive structure and the cylindrical battery assembly is arranged in a non-coaxial manner.

In some embodiments, the directive structure includes a first directional portion and/or a second directional portion and/or a third directional portion. The first directional portion is arranged on the housing, the second directional portion is arranged on the insulating part, and the third directional portion is arranged on the first top cover and/or the second top cover.

In some embodiments, the first directional portion is arranged on a peripheral surface of the housing and is a groove shape.

In some embodiments, the first directional portion is arranged at the bottom of the housing and is a first protrusion or a first recess.

In some embodiments, the second directional portion is a second recess or a second protrusion arranged on a side of the insulating part away from the interior of the housing.

In some embodiments, the third directional portion is a third recess or a third protrusion having different shapes and arranged on the first top cover and the second top cover.

In some embodiments, the shape of the orthographic projection of the third recess or the third protrusion on the first top cover and/or the second top cover is one of a circle, a triangle, a rectangle, a trapezoid, a sector, a pentagon, or a hexagon.

In some embodiments, a fourth protrusion or a fourth recess is arranged on both of the first top cover and the second top cover, and the third directional portion is a marking portion arranged on the fourth protrusion or the fourth recess.

In some embodiments, the marking portion has a linear shape or a cross shape.

Some other embodiments of the disclosure further aim to provide a cylindrical battery, including the cylindrical battery assembly as previously described, and further including an electrode assembly arranged in the housing. The electrode assembly is provided with a first tab and a second tab opposite to the first tab in polarity, the first tab and the second tab are located on the same end surface of the electrode assembly, the first tab is connected to the first top cover, and the second tab is connected to the second top cover.

The beneficial effects of the disclosure lie in that, for the cylindrical battery assembly, the housing, the top cover assembly and the directive structure are used cooperatively, the directive structure is arranged in an eccentric position of the housing and/or top cover assembly, the directive structure and the cylindrical battery assembly are arranged in a non-coaxial manner for distinguishing the polarities of the first top cover and the second top cover, so that potential safety hazards caused by the fact that the cylindrical battery is connected to the external electric connecting sheet in reversed polarity since the shapes of the first top cover and the second top cover are similar can be effectively avoided in the cylindrical battery assembly process.

### BRIEF DESCRIPTION OF THE DRAWINGS

The features, advantages, and technical effects of embodiments of the disclosure will be described below with reference to the accompanying drawings.

FIG. 1 is a structural schematic diagram of the disclosure.

FIG. 2 is another structural schematic diagram of the disclosure.

FIG. 3 is yet another structural schematic diagram of the disclosure.

FIG. 4 is a structural schematic diagram of a top cover assembly of the disclosure.

FIG. 5 is another structural schematic diagram of a top cover assembly of the disclosure.

FIG. 6 is yet another structural schematic diagram of a top cover assembly of the disclosure.

FIG. 7 is a cross-sectional schematic diagram of the disclosure.

FIG. 8 is a structural schematic diagram of part A in FIG. 7.

FIG. 9 is a structural schematic diagram of an electrode assembly of the disclosure.

### REFERENCE NUMERALS ARE EXPLAINED BELOW

100, cylindrical battery;
10, housing; 11, bottom wall; 12, side wall; 121, beading portion; 122, crimping portion;
20, top cover assembly; 21, first top cover; 22, second top cover; 23, insulating part; 24, fourth protrusion; 25, fourth recess;
30, directive structure; 31, first directional portion; 32, second directional portion; 33, third directional portion;
40, insulating seal;
50, electrode assembly; 51, first tab; 52, second tab; and
60, insulating blocking member.

### DETAILED DESCRIPTION OF THE EMBODIMENTS

Certain terms are used, for example, in the description and claims to refer to particular components. Those skilled in the art should understand that a hardware manufacturer may use different terms to refer to the same component. The specification and claims do not use the difference in name as a way to distinguish components, but use the difference in function of components as a criterion for distinguishing. As mentioned throughout the specification and claims, “comprising” is an open term, so it should be interpreted as “including but not limited to”. “Approximately” means that within an acceptable error range, those skilled in the art can solve technical problems within a certain error range and basically achieve technical effects.

In addition, terms “first” and “second” are only used for describing purposes, and cannot be understood as indicating or implying relative importance.

The term “and/or” in the disclosure describes only an association relationship for describing associated objects and represents that three relationships may exist. For example, A and/or B may represent the following three cases: only A exists, both A and B exist, and only B exists. In addition, the character “/” in the disclosure generally indicates that the contextual objects are an “or” relationship.

In the disclosure, unless otherwise clearly specified and limited, the terms “installation”, “mutual connection”, “connection”, “fixation” and other terms shall be understood in a broad sense. For example, the term may be a fixed connection or a detachable connection, or an integrated connection; the term may be a mechanical connection or an electric connection; and the term may be a direct connection or an indirect connection through an intermediary, and may be communication inside two components. Those of ordinary skill in the art may understand the specific meanings of the terms in the disclosure according to specific conditions.

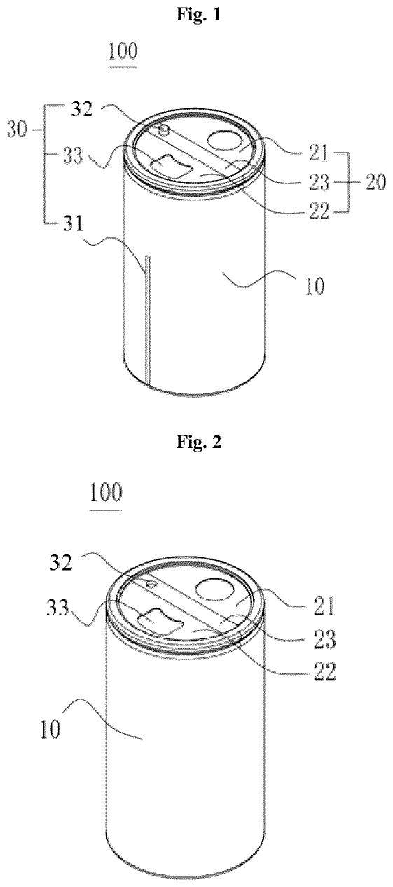

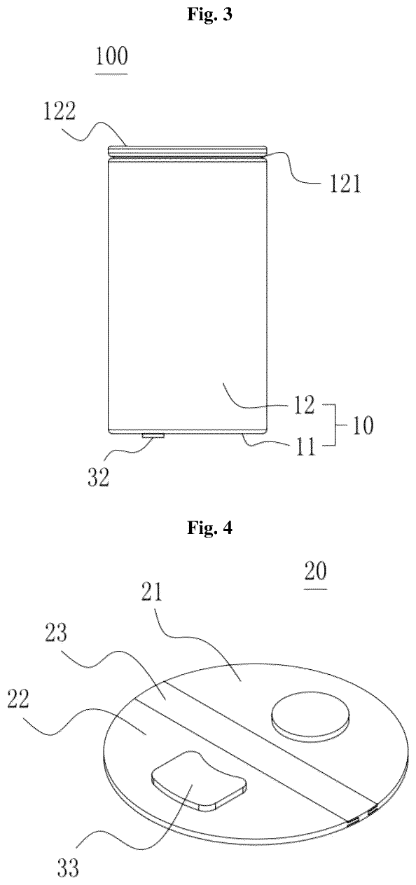

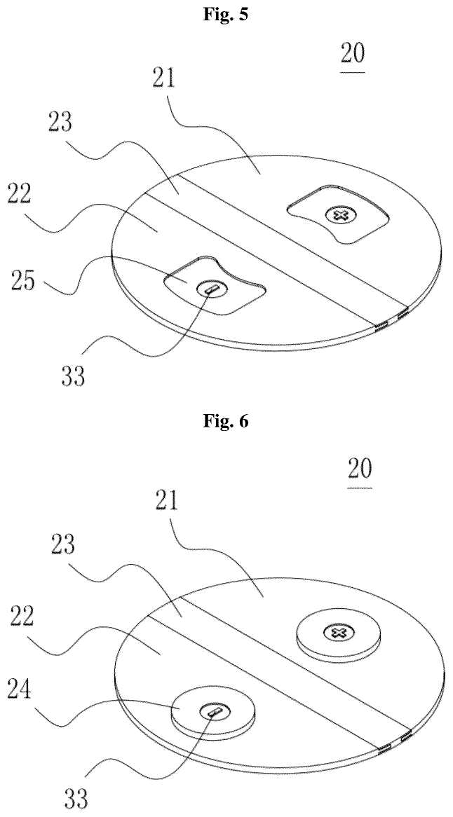

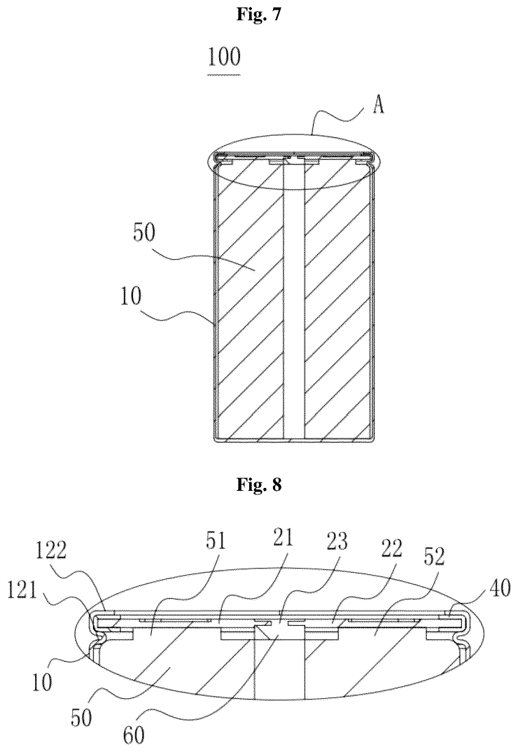

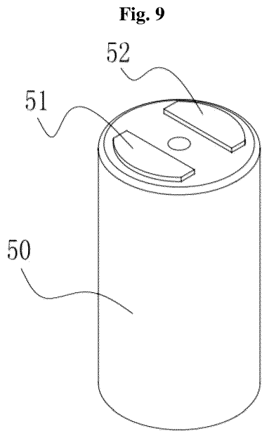

The disclosure will be described in further detail below in conjunction with accompanying FIGS. 1-9, but is not limited thereto.

Some embodiments of the disclosure provide a cylindrical battery assembly, which includes a housing 10 and a top cover assembly 20. The housing 10 is provided with an opening, and the top cover assembly 20 seals the opening in an insulating manner. The housing 10 is configured to accommodate an electrode assembly 50 of a cylindrical battery 100.

The housing 10 according to the embodiment of the disclosure is a cylinder.

Specifically, the housing 10 includes a side wall 12 and a bottom wall 11. The side wall 12 surrounds an outer side of the electrode assembly 50, and the bottom wall 11 is connected to an end of the side wall 12. The side wall 12 is of a cylindrical structure, the bottom wall 11 is of a plate-shaped structure, and the shape of the bottom wall 11 corresponds to the shape of the side wall 12. In some embodiments, an opening is formed at one end of the side wall 12, and the bottom wall 11 is connected to the other end of the side wall 12 away from the opening.

The side wall 12 and the bottom wall 11 are an integrally formed structure, i.e., the housing 10 is an integrally formed member. Of course, the side wall 12 and the bottom wall 11 are also able to be two members provided separately, and then connected together by welding, riveting, bonding, or the like.

The side wall 12 includes a beading portion 121 formed at a lower part of the top cover assembly 20 and a crimping portion 122 formed on an upper part of the top cover assembly and bent inward. Before the cylindrical battery 100 is pier-sealed, the beading portion 121 needs to be arranged on the side wall 12 of the housing to prepare for pier-sealing of the cylindrical battery 100. After the cylindrical battery 100 is pier-sealed, the crimping portion 122 of the side wall 12 is formed on the upper part of the top cover assembly 20 and bent inward.

The top cover assembly 20 in the embodiments of the disclosure includes a first top cover 21, a second top cover 22, and an insulating part 23. The polarity of the first top cover 21 is opposite to the second top cover 22, and the first top cover 21 is connected to the second top cover 22 in an insulating manner. By a cooperative use of the first top cover 21, the second top cover 22 and the insulating part 23, the top cover assembly 20 is effectively caused to have different polarities without arranging an electrode post, and a height space of the cylindrical battery 100 is saved, thereby improving an energy density of the cylindrical battery 100. Meanwhile, the electrode post processing is omitted, the equipment for processing the electrode post is omitted, the top cover assembly processing efficiency is improved, and the cost is reduced.

It is to be noted that, when the first top cover 21 is a positive electrode, the second top cover 22 is a negative electrode; and when the first top cover 21 is a negative electrode, the second top cover 22 is a positive electrode.

In order to improve a bonding force and an air tightness between the first top cover 21, the second top cover 22 and the insulating part 23, a plurality of nanopores are arranged on a surface of the first top cover 21 and/or the second top cover 22 connected to the insulating part 23, and the insulating part 23 is partially embedded in the plurality of nanopores. The insulating part 23 is arranged between the first top cover 21 and the second top cover 22 in an injection molding manner.

Specifically, the plurality of nanopores are formed by laser engraving or chemical corrosion. In addition, compared with common chemical corrosion treatment, the laser engraving has a higher pore-forming rate, a higher efficiency, and is more environmentally friendly, and required morphology, pore size, pore distribution density and the like of the plurality of nanopores are able to be obtained by adjusting engraving parameters.

Further, the cross-sectional shape of the insulating part 23 is one of a linear shape, a cross shape, an I-shaped shape, a “ [symbol] ” shape and a “ [symbol] ” shape.

In some embodiments of the disclosure, a directive structure 30 is arranged on the housing 10 and/or the top cover assembly 20, and the directive structure 30 and the cylindrical battery assembly are arranged in a non-coaxial manner. By arranging the directive structure 30, the first top cover 21 or the second top cover 22 is marked by means of a position of the directive structure 30 or a projection of the directive structure 30 during assembly, for example, the directive structure 30 or the projection of the directive structure 30 is located on the first top cover 21 or the second top cover 22, so that the polarity of the first top cover 21 and the polarity of the second top cover 22 are directly distinguished. Also, by a cooperation between the directive structure 30 and an assembly jig of the cylindrical battery 100, the assembly jig is marked in advance, the assembly jig located on one side of the mark is a positive electrode or a negative electrode, and the polarity of the assembly jig located on the other side of a mark is opposite to the polarity of the one side of the mark. During assembly, the directive structure 30 is aligned with the mark on the assembly jig, so that the first top cover 21 and the second top cover 22 are respectively located on two sides of the assembly jig, that is, the polarities of the first top cover 21 and the second top cover 22 are distinguished.

It is to be noted that, when the housing 10 and the top cover assembly 20 are both provided with the directive structure 30, the directive structure 30 and/or the projection of the directive structure 30 are located on the first top cover 21 and the second top cover 22, or are located between the first top cover 21 and the second top cover 22, or are located on the first top cover 21 and the second top cover 22 and between the first top cover 21 and the second top cover 22. When the directive structure 30 and/or the projection of the directive structure 30 are located on the first top cover 21 and the second top cover 22, in order to distinguish the polarity of the first top cover 21 and the polarity of the second top cover 22, a shape of the directive structure 30 or the projection of the directive structure 30 of the first top cover 21 is kept different from a shape of the directive structure 30 or the projection of the directive structure 30 of the second top cover 22, or the shape of the directive structure 30 of the first top cover 21 is kept different from the shape of the projection of the directive structure 30 of the second top cover 22, or the shape of the projection of the directive structure 30 of the first top cover 21 is kept different from the shape of the directive structure 30 of the second top cover 22.

In comparison with the related art, the embodiments of the disclosure provide a cylindrical battery assembly. The housing 10, the top cover assembly 20 and the directive structure 30 are used cooperatively, the directive structure 30 is arranged on the housing 10 and/or top cover assembly 20, the directive structure 30 and the cylindrical battery assembly are arranged in a non-coaxial manner for distinguishing the polarity of the first top cover 21 and the polarity of the second top cover 22, so that a potential safety hazard caused by the fact that the cylindrical battery 100 is connected to an external electrical connecting sheet in reversed polarity due to the fact that the shapes of the first top cover 21 and the second top cover 22 are similar is effectively avoided during an assembly process of the cylindrical battery 100.

It is to be noted that the directive structure 30 and the cylindrical battery assembly are arranged in a non-coaxial manner, and the axis refers to a central axis.

The directive structure 30 in the embodiments of the disclosure includes a first directional portion 31 and/or a second directional portion 32 and/or a third directional portion 33. The first directional portion 31 is arranged on the housing 10, the second directional portion 32 is arranged on the insulating part 23, and the third directional portion 33 is arranged on the first top cover 21 and/or the second top cover 22. By a cooperative use of the first directional portion 31, the second directional portion 32 and the third directional portion 33, the polarities of the first top cover 21 and the second top cover 22 are able to be distinguished, so that the fact that the cylindrical battery 100 is connected to the external electrical connecting sheet in reversed polarity due to the fact that the shapes of the first top cover 21 and the second top cover 22 are similar is effectively avoided.

In some embodiments, the first directional portion 31 is arranged on a peripheral surface of the housing 10 and is a groove shape. When the first directional portion 31 is located on the same side as the first top cover 21 or the second top cover 22, the first top cover 21 or the second top cover 22 is marked, so that the polarities of the first top cover 21 and the second top cover 22 are distinguished.

In some embodiments, the first directional portion 31 is arranged at the bottom of the housing 10 and is a first protrusion or a first recess. The orthographic projection of the first directional portion 31 is located on the first top cover 21 or the second top cover 22, and the first top cover 21 and the second top cover 22 are marked to distinguish the polarities of the first top cover 21 and the second top cover 22. The orthographic projection of the first directional portion 31 is also located between the first top cover 21 and the second top cover 22, so that the first directional portion 31 is matched with the assembly jig to distinguish the polarities of the first top cover 21 and the second top cover 22 during assembly.

Further, the cross-sectional shape of the first protrusion or the first recess is one of a circle, a rectangle, a trapezoid or a sector. With the above arrangement, the shape selection of the first directional portion 31 is effectively increased.

In some embodiments, the second directional portion 32 is a second recess or a second protrusion arranged on a side of the insulating part 23 away from the interior of the housing That is, the second directional portion 32 is located on the upper surface of the insulating part 23. The second directional portion 32 is located between the first top cover 21 and the second top cover 22. During assembly, the polarity of the first top cover 21 and the polarity of the second top cover 22 are distinguished by a cooperation between the second directional portion 32 and the assembly jig of the cylindrical battery 100.

In some embodiments, the third directional portion 33 is a third recess or a third protrusion having different shapes and arranged on the first top cover 21 and the second top cover 22. The third directional portion 33 is able to directly mark the first top cover 21 and the second top cover 22, and directly distinguish the polarities of the first top cover 21 and the second top cover 22.

Further, a shape of the orthographic projection of the third recess or the third protrusion on the first top cover 21 and/or the second top cover 22 is one of a circle, a triangle, a rectangle, a trapezoid, a sector, a pentagon or a hexagon. The shape selection of the third recess or the third protrusion is increased and is set according to actual needs when in use.

In some embodiments, a fourth protrusion 24 or a fourth recess 25 is arranged on both of the first top cover 21 and the second top cover 22, and the third directional portion 33 is a marking portion arranged on the fourth protrusion 24 or the fourth recess 25. The marking portion is able to directly mark the first top cover 21 and the second top cover 22 and directly distinguish the polarities of the first top cover 21 and the second top cover 22.

Further, the marking portion has a linear shape or a cross shape. By setting the shape of the marking portion, the marking portion has the linear shape or the cross shape, thus effectively increasing the shape selection of the marking portion.

In the embodiments of the disclosure, an insulating seal 40 is arranged between the housing 10 and the top cover assembly 20, so that the cylindrical battery 100 is effectively prevented from being short-circuited due to the fact that the housing 10 is electrically connected to the top cover assembly 20.

Further, the insulating seal 40 and the insulating part 23 are a separate structure or are integrally formed. When the insulating seal 40 and the insulating part 23 are integrally formed, a space for installing the first top cover 21 and the second top cover 22 needs to be reserved between the insulating seal 40 and the insulating part 23, so as to ensure subsequent connections of a first tab 51 to the first top cover 21 and of a second tab 52 to the second top cover 22.

Some other embodiments of the disclosure provide a cylindrical battery, including the cylindrical battery assembly in the above embodiments, and further including an electrode assembly 50 arranged in the housing 10. The electrode assembly 50 is provided with a first tab 51 and a second tab 52 opposite to the first tab 51 in polarity, the first tab 51 and the second tab 52 are located on the same end surface of the electrode assembly 50, the first tab 51 is connected to the first top cover 21, and the second tab 52 is connected to the second top cover 22.

In comparison with the related art, some other embodiments of the disclosure provide the cylindrical battery, the electrode assembly 50 and the cylindrical battery assembly are cooperatively used, the electrode assembly 50 is arranged in the housing 10, the cylindrical battery assembly is provided with the directive structure 30, and the directive structure 30 is arranged on the housing 10 and/or the top cover assembly 20, and the directive structure 30 and the cylindrical battery assembly are arranged in a non-coaxial manner for distinguishing the polarity of the first top cover 21 and the polarity of the second top cover 22, so that the potential safety hazard caused by the fact that the cylindrical battery 100 is connected to the external electrical connecting sheet in reversed polarity due to the fact that the shapes of the first top cover 21 and the second top cover 22 are similar is effectively avoided during an assembly process of the cylindrical battery 100.

Further, in order to prevent the contact between the first tab 51 and the second tab 52 from causing a short circuit of the cylindrical battery 100, an insulating blocking member 60 is arranged between the first tab 51 and the second tab 52. The insulating blocking member 60 is located at the bottom of the insulating part 23 and is able to be integrally formed with the insulating part 23.

The electrode assembly 50 in some other embodiments of the disclosure includes a positive electrode plate, a negative electrode plate and a separator. The cylindrical battery 100 runs mainly relying on the movement of metal ions between the positive electrode plate and the negative electrode plate. The positive electrode plate includes a positive current collector and a positive active material layer, and the positive active material layer is coated on a surface of the positive current collector. The positive current collector includes a positive coating area and a positive tab connected to the positive coating area, the positive coating area is coated with the positive active material layer, and the positive tab is not coated with the positive active material layer. Taking a lithium-ion battery 100 as an example, the material of the positive current collector is aluminum. The positive active material layer includes a positive active material, and the positive active material is lithium cobaltate, lithium iron phosphate, ternary lithium or lithium manganate, etc. The negative electrode plate includes a negative current collector and a negative active material layer, and the negative active material layer is coated on a surface of the negative current collector. The negative current collector includes a negative coating area and a negative tab connected to the negative coating area, the negative coating area is coated with the negative active material layer, and the negative tab is not coated with the negative active material layer. The material of the negative current collector is copper, the negative active material layer includes a negative active material, and the negative active material is carbon, or silicon, etc. The material of the separator may be polypropylene (PP) or polyethylene (PE).

According to the disclosure and teaching of the above specification, those skilled in the art to which the disclosure pertains can also change and modify the above embodiments. Therefore, the disclosure is not limited to the above specific embodiments, and any obvious improvement, substitution or modification made by those skilled in the art on the basis of the disclosure shall fall within the protection scope of the disclosure. In addition, although some specific terms are used in the specification, these terms are only for convenience of description and do not constitute any limitation to the disclosure.

What is claimed is:

1. A cylindrical battery assembly, comprising a housing and a top cover assembly, the housing is provided with an opening, and the top cover assembly seals the opening in an insulating manner, the top cover assembly comprises a first top cover, a second top cover and an insulating part, the polarity of the first top cover is opposite to the polarity of the second top cover, the first top cover is connected to the second top cover in an insulating manner by the insulating part, a directive structure is arranged on the housing and/or the top cover assembly, and the directive structure and the cylindrical battery assembly are arranged in a non-coaxial manner.

2. The cylindrical battery assembly according to claim 1, wherein the directive structure comprises a first directional portion and a second directional portion and/or a third directional portion, the first directional portion is arranged on the housing, the second directional portion is arranged on the insulating part, and the third directional portion is arranged on the first top cover and/or the second top cover.

3. The cylindrical battery assembly according to claim 2, wherein the first directive portion is arranged on a peripheral surface of the housing and is a groove shape.

4. The cylindrical battery assembly according to claim 2, wherein the first directive portion is arranged at the bottom of the housing and is a first protrusion or a first recess.

5. The cylindrical battery assembly according to claim 4, wherein the orthographic projection of the first directional portion is located on the first top cover or the second top cover, or is located between the first top cover and the second top cover.

6. The cylindrical battery assembly according to claim 2, wherein the second directional portion is a second recess or a second protrusion arranged on a side of the insulating part away from the interior of the housing.

7. The cylindrical battery assembly according to claim 2, wherein the third directional portion is a third recess or a third protrusion having different shapes and arranged on the first top cover and the second top cover.

8. The cylindrical battery assembly according to claim 7, wherein the shape of the orthographic projection of the third recess or the third protrusion on the first top cover and the second top cover is one of a circle, a triangle, a rectangle, a trapezoid, a sector, a pentagon, or a hexagon.

9. The cylindrical battery assembly according to claim 2, wherein a fourth protrusion or a fourth recess is arranged on both of the first top cover and the second top cover, and the third directional portion is a marking portion arranged on the fourth protrusion or the fourth recess.

10. The cylindrical battery assembly according to claim 9, wherein the marking portion has a linear shape or a cross shape.

11. A cylindrical battery, comprising the cylindrical battery assembly according to claim 1, and further comprising an electrode assembly arranged in the housing, the electrode assembly is provided with a first tab and a second tab opposite to the first tab in polarity, the first tab and the second tab are located on the same end surface of the electrode assembly, the first tab is connected to the first top cover, and the second tab is connected to the second top cover.

12. The cylindrical battery according to claim 11, wherein the directive structure comprises a first directional portion and/or a second directional portion and/or a third directional portion, the first directional portion is arranged on the housing, the second directional portion is arranged on the insulating part, and the third directional portion is arranged on the first top cover and/or the second top cover.

13. The cylindrical battery according to claim 12, wherein the first directional portion is arranged on a peripheral surface of the housing and is in a groove shape.

14. The cylindrical battery according to claim 12, wherein the first directional portion is arranged at the bottom of the housing and is a first protrusion or a first recess.

15. The cylindrical battery according to claim 14, wherein the orthographic projection of the first directional portion is located on the first top cover or the second top cover, or is located between the first top cover and the second top cover.

16. The cylindrical battery according to claim 12, wherein the second directional portion is a second recess or a second protrusion arranged on a side of the insulating part away from the interior of the housing.

17. The cylindrical battery according to claim 12, wherein the third directional portion is a third recess or a third protrusion having different shapes and arranged on the first top cover and the second top cover.

18. The cylindrical battery according to claim 17, wherein a shape of the orthographic projection of the third recess or the third protrusion on the first top cover and the second top cover is one of a circle, a triangle, a rectangle, a trapezoid, a sector, a pentagon, or a hexagon.

19. The cylindrical battery according to claim 12, wherein a fourth protrusion or a fourth recess is arranged on both of the first top cover and the second top cover, and the third directional portion is a marking portion arranged on the fourth protrusion or the fourth recess.

20. The cylindrical battery according to claim 19, wherein the marking portion has a linear shape or a cross shape.
